(19) United States
(12) Patent Application Publication
(10) Pub. No.: US 2018/0306963 A1
(43) Pub. Date: Oct. 25, 2018

(54) TRANSPARENT STRUCTURE, DISPLAY DEVICE, HOUSEHOLD APPLIANCE AND METHOD OF MANUFACTURING A TRANSPARENT STRUCTURE

(71) Applicant: PAS Deutschland GmbH, Neuruppin (DE)

(72) Inventor: Marek KLIMECKI, Neuruppin (DE)

(21) Appl. No.: 15/960,864

(22) Filed: Apr. 24, 2018

(30) Foreign Application Priority Data
Apr. 25, 2017 (DE) 10 2017 108 829.6

(51) Int. Cl. F21V 8/00; H05B 37/02; D06F 39/14; G09F 13/18

(52) U.S. Cl. CPC G02B 6/0035; H05B 37/0218; B29C 45/16; G09F 13/18; D06F 39/14

(57) ABSTRACT

Transparent structure comprising a first material having a high first transparency with a scattering property and a second material having a high second transparency, wherein the first and second materials are arranged in a plane with a normal vector and a view through the structure is given in the direction of the normal vector, the structure having a peripheral region, which is configured at least for the most part such that light propagating in the structure at least approximately perpendicular to the normal vector is reflected from the peripheral region back into the structure, and wherein the scattering property is such that light propagating perpendicular to the normal vector by the structure is deflected at least partially to the direction of the normal vector. In addition, a display device, a household appliance and a method for producing a transparent structure are disclosed.

### CROSS REFERENCES TO RELATED APPLICATIONS

This application claims priority from German patent application DE 10 2017 108 829.6, filed on Apr. 25, 2017. The entire contents of this priority application is incorporated herein by reference.

### BACKGROUND

The disclosure relates to a transparent structure, a display device with a transparent structure, a household appliance, in particular a washing machine or tumble dryer, with a porthole and a transparent structure, and a method of producing a transparent structure.

With various objects of daily life, especially household appliances, there is always the need to display information. However, there is the problem that additional space must be made available to display this information or, if a space is needed that is already in use, the display of the information is perceived as unwelcome.

It is therefore one of the objects to find a solution to this problem that does not require additional space and is not perceived as unwelcome.

### SUMMARY OF THE DISCLOSURE

According to a first aspect, the object is addressed by a transparent structure comprising a first material having a high first transparency with a scattering property and a second material having a high second transparency, wherein the first and second materials are arranged in a plane with a normal vector and a view through the structure is given in the direction of the normal vector, the structure having a peripheral region which is at least for the most part configured to be reflective such that light propagating in the structure at least approximately perpendicular to the normal vector is reflected from the peripheral region back into the structure, and wherein the scattering property is configured such that light propagating perpendicular to the normal vector through the structure is at least partially deflected to the direction of the normal vector.

A special feature of this transparent structure is the arrangement of the two materials in one level. If the transparent structure is viewed in the direction of the normal vector, the first and second materials are arranged next to each other. The functional principle of this arrangement in one plane is as follows.

Light, especially visible light, propagates in this plane through the transparent structure. When the light propagates through the second material, only a minimal, negligible scattering of the light occurs because the second material has no special scattering property. In particular, it is desired that the second material has only a very low scatter, preferably substantially no scatter and especially preferably no scatter. In general, a possibly existing scatter in the second material is chosen less, in particular much less than in the first material. An example of the first material is PMMA (polymethyl methacrylate) called LED LD24 8N from Evonik Industries AG.

When the light hits the peripheral region or edge of the transparent structure, it is reflected back into the structure. Therefore, as long as the light propagates through the second material, essentially no light escapes from the structure, but remains essentially in the plane.

When the light from the second material enters the first material, perhaps after it has been reflected once or several times from the peripheral area or edge area, the light is now in a material with the scattering property. Here it is therefore expressly desired to deflect the light at least partially from the plane to the direction of the normal vector. As a result, more light exits the plane from the sections of the structure formed from the first material, especially at least approximately in the direction of the normal vector, than in the sections formed from the second material.

For human perception, this means that the sections formed from the first material appear illuminated in relation to the sections formed from the second material. In turn, the areas of the first material form a visible contrast to the areas of the second material, so that the shape of the second material can be perceived. The sections made of the first material can represent shapes, such as lines, rectangles, circles or polygons, or characters, such as letters and numbers.

In comparison, if no light is propagating within the plane, and thus there is hardly any difference as to how much light is emitted from the first material and the second material at least approximately in the direction of the normal vector, a contrast between the first material and the second material is hardly recognizable. The shaping of the first material in comparison to the second material is thus hardly perceptible or even no longer perceptible. The information contained in the design of the materials has disappeared for the viewer.

Since the materials as such have a high transparency, a view through the entire transparent structure is given if no light or only a small amount of light propagates in the plane. Any differences in the transparency of the first and second material are not perceived as disturbing. If, on the other hand, a certain amount of light propagates in the plane of the structure, the shape of the first material in the second material becomes visible, so that the information contained can be perceived. By specifically controlling the amount of light at the level of the structure, the information can be displayed at times when it is not perceived as unwelcome.

The exact choice of the first transparency and the second transparency depends on the specific application. If maximum transparency is to be provided by the structure, the second transparency is chosen as high as possible, naturally also taking into account material and production costs. If the structure should have a slight frosted glass effect, the second transparency can be selected somewhat less. However, it must be noted that this also deflects more light from the plane in the second material and not only in the first material. This can reduce the perceptible contrast between the first and second material. It must also be ensured that sufficient light still enters the first material to ensure that the scattering property of the first material still deflects sufficient light in the direction of the normal vector. In particular, this should be a significantly greater amount of light that is deflected in the first material than in the second material, so that the shape of the first material is sufficiently visible in contrast to the second material.

According to current estimates, it is therefore advisable to choose the second material as transparent as possible, i.e. in particular without a scattering property. The first material is also selected as transparent as possible, although a scattering property is now expressly desired here. The transparency and scattering properties are selected in such a way that the shape of the first material is imperceptible or hardly perceptible if only a small amount of light is propagating in the first plane, and the shape of the first material is clearly visible if a larger amount of light is propagating in the plane.

In this way, a first state can be achieved in which the transparent structure is perceived at least essentially as completely transparent, and a second state in which the areas of the second material remain transparent and the areas of the first material now become perceivable and the information contained is perceptible.

It should be noted that the direction of the view through the transparent structure, in the sense of an explanation of the disclosure, is along the normal vector of the plane. In practice, the user will look though the structure generally at an angle, especially at a small angle, to the normal vector.

In an exemplary embodiment, the plane is at least approximately parallel to a surface of the structure.

The transparent structure has its spatial extension preferably in the mentioned plane and is thin in relation to the direction of the normal vector. The extension of the structure with respect to at least one direction in the plane is preferably at least twice as large, especially preferably at least five times as large and in particular at least ten times as large as the extension of the structure in the direction of the normal vector.

In another exemplary embodiment, the first transparency and/or the second transparency has an ASTM 1003 Haze value of less than 10%, preferably less than 7%, especially preferably less than 5% and in particular less than 3%.

These values are assumed to be advantageous for the realization of the transparent structure. In tests, the first transparency was chosen with approximately 3% and the second transparency slightly lower.

In another exemplary embodiment, an element reflecting into the interior of the structure is arranged on the peripheral area, in particular a reflective layer.

This design makes it possible to keep as much light as possible within the structure and to ensure that the light leaves the structure at least essentially only through the areas with the first material.

In another exemplary embodiment, the transmittance of the first material in the direction of the normal vector is 85%-96%, preferably 87%-94%, especially preferably 88%-93% and in particular 89%-92%.

These values are assumed to be advantageous based on practical tests.

In another exemplary embodiment, the refractive index of the first material is 1.4-1.6, preferably 1.45-1.55, particularly preferably 1.48-1.51 and in particular 1.49-1.495.

These values are assumed to be advantageous based on practical tests.

In another exemplary embodiment, a coupling area is formed at the peripheral area in such a way that light from a light source is evenly coupled into the structure, the coupled light propagating at least approximately perpendicular to the normal vector.

This embodiment may make it easy to couple light into the structure, which is then decoupled as much as possible only via the first material. The specific design of the coupling area depends on the light source used. The skilled person can determine the geometry of the coupling area by means of simulations or practical tests. Two or more coupling areas may be used, which may increase the homogeneity of the light coupling, especially with a larger structure.

In another exemplary embodiment, the peripheral area is essentially circular in shape.

Such an embodiment of the peripheral area may allow for a good light distribution within the structure. It also seems to allow light to enter the first material from many directions within the structure, so that a shape formed by the first material appears substantially uniformly illuminated and not just from one side.

In another exemplary embodiment, the first material protrudes in the direction of the normal vector beyond the second material.

Such an embodiment may improve the perceptibility of the shape by the first material, especially if the transparent structure is viewed at a larger angle to the normal vector. The first material protruding in the direction of the normal vector beyond the second material forms a protrusion.

In another exemplary embodiment, the protrusion comprises at least one rounded or chamfered edge.

This embodiment may also improve the perception of the shape of the first material. In exemplary embodiments all edges of the protrusion are rounded or chamfered.

In a further exemplary embodiment, the second material is arranged only next to the first material in relation to the normal vector.

In general, the second material may also be arranged in front of and/or behind the first material due to its transparency in relation to the normal vector. However, it is considered advantageous for exemplary embodiments if the second material is arranged exclusively next to the first material. In other words, the second material is neither before nor behind the first material in relation to the normal vector.

In a further exemplary embodiment the brightness of the light source can be adapted based on information from a brightness sensor detecting an environmental brightness. The adaptation may be performed such that the brightness of the light source is higher when the environmental brightness is high and that the brightness of the light source is lower when the environmental brightness is low. The brightness sensor may be comprised in a household appliance holding the transparent structure.

According to a second aspect of the disclosure, the object is addressed by a display device with a transparent structure described above and a light source configured to couple light into the structure at least approximately perpendicular to the normal vector.

According to a third aspect of the disclosure, the object is addressed by a household appliance, in particular a washing machine or tumble dryer, with a porthole and a transparent structure described above, the porthole having the structure or the structure forming the porthole.

According to a fourth aspect, the object is addressed by a method for producing a transparent structure described above, the method comprising the steps of:
injection molding of at least one first element from a first material having a high first transparency with a scattering property,
arranging the at least one first element in a plane having a normal vector,
injection molding of a second element from a second material having a high first transparency around the at least one first element to obtain the structure, the first and second materials being arranged in the plane and providing a view through the structure in the direction of the normal vector, and
forming of a peripheral region configured reflectively so that at least for the most part light propagating in the structure at least approximately perpendicular to the normal vector is reflected from the peripheral region back into the structure,

wherein the scattering property is such that light propagating perpendicular to the normal vector through the structure is at least partially deflected to the direction of the normal vector.

It is understood that the features mentioned above and those to be explained below can be used not only in the combination indicated, but also in other combinations or in isolation, without leaving the scope of this disclosure.

### BRIEF DESCRIPTION OF THE DRAWINGS

Exemplary embodiments are shown in the drawings and are explained in more detail in the following description. In the drawings:

FIG. 1 shows a plan view along the normal vector onto a transparent structure according to an exemplary embodiment;

FIG. 2 shows a perspective view of a section through the structure according to FIG. 1;

FIG. 3 shows an enlarged representation of the spatial arrangement of the first and second material according to FIG. 1;

FIG. 4 shows a perspective view of the coupling area of the structure according to FIG. 1;

FIG. 5 shows a simplified representation of the light distribution in the structure according to FIG. 1;

FIG. 6 shows a household appliance with a porthole according to an exemplary embodiment; and

FIG. 7 shows a method for producing a transparent structure according to an exemplary embodiment.

### DESCRIPTION OF EXEMPLARY EMBODIMENTS

FIG. 1 shows an embodiment of a transparent structure 10. The structure 10 shows a first material 12 with a high first transparency and a scattering property, and a second material 14 with a high second transparency. The first and second materials 12, 14 are arranged in a plane 16 with a normal vector 18, where the plane 16 is parallel to the drawing plane of FIG. 1 and the normal vector 18 protrudes vertically from the drawing plane of FIG. 1. There is a view through structure 10 in the direction of normal vector 18. It should be noted that nothing changes in the fundamental considerations if one considers a direction opposite to the normal vector instead of the direction of the normal vector.

The structure 10 comprises a peripheral region 20 which is at least largely configured to reflect light 22—here symbolically represented by arrow lines—which is propagating in the structure 10 at least approximately perpendicular to normal vector 18, back from peripheral region 20 into the structure 10.

The scattering property of the first material 12 is such that light 22, propagating perpendicular to the normal vector 18 through the structure 10, is at least partially deflected to the direction of the normal vector 18.

The plane 16 is parallel to a surface 24 of the structure 10. An element 26 reflecting into the interior of the structure 10 is arranged on the peripheral area, where-by the reflecting element 26 in this embodiment is configured as a coating.

At the peripheral region 20, a coupling region 28 is configured in such a way that light 22 from a light source 30, see FIG. 5, is evenly coupled into the structure 10, the coupled light 22 propagating at least approximately perpendicular to the normal vector 18.

The peripheral area 20 has an essentially circular shape.

Finally, a cutting line 32 is shown in FIG. 1 to indicate a section.

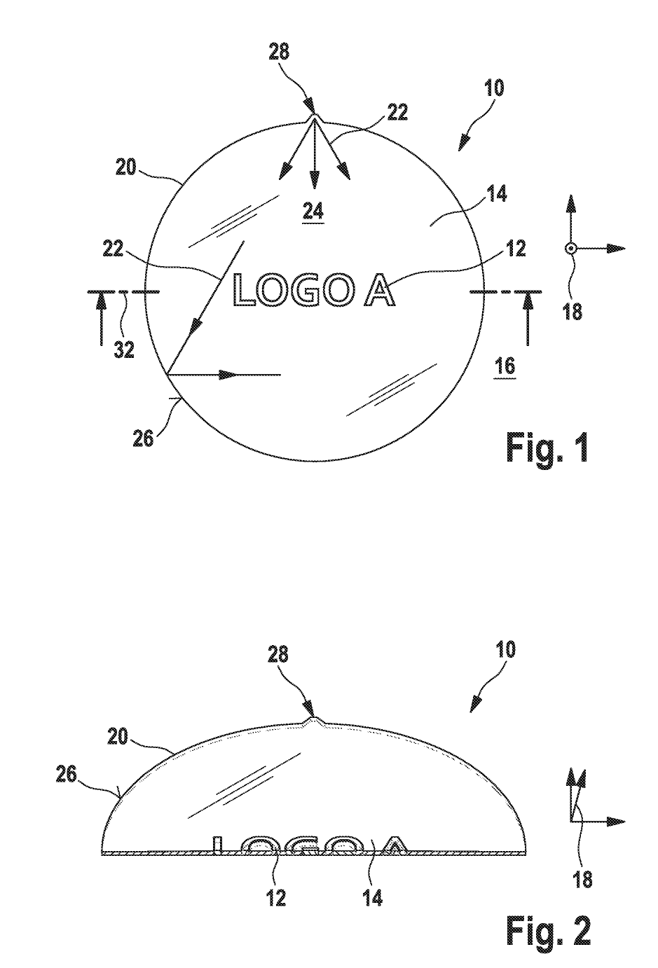

FIG. 2 shows a view of the transparent structure 10 according to FIG. 1 after a cut along the cutting line 32. For this figure and all following figures the same reference numerals are used for the same elements.

This figure shows the shape of the first material 12. The shape of the first material 12, which appears when viewed along the normal vector 18, reflects the information that a user should perceive. The expansion of the first material 12 in the direction of the normal vector 18 is used for embedding in the second material 14, so that light from the second material 14 can be received by the first material 12 and then be decoupled from the structure 10 via the scattering property at least approximately in the direction of the normal vector 18.

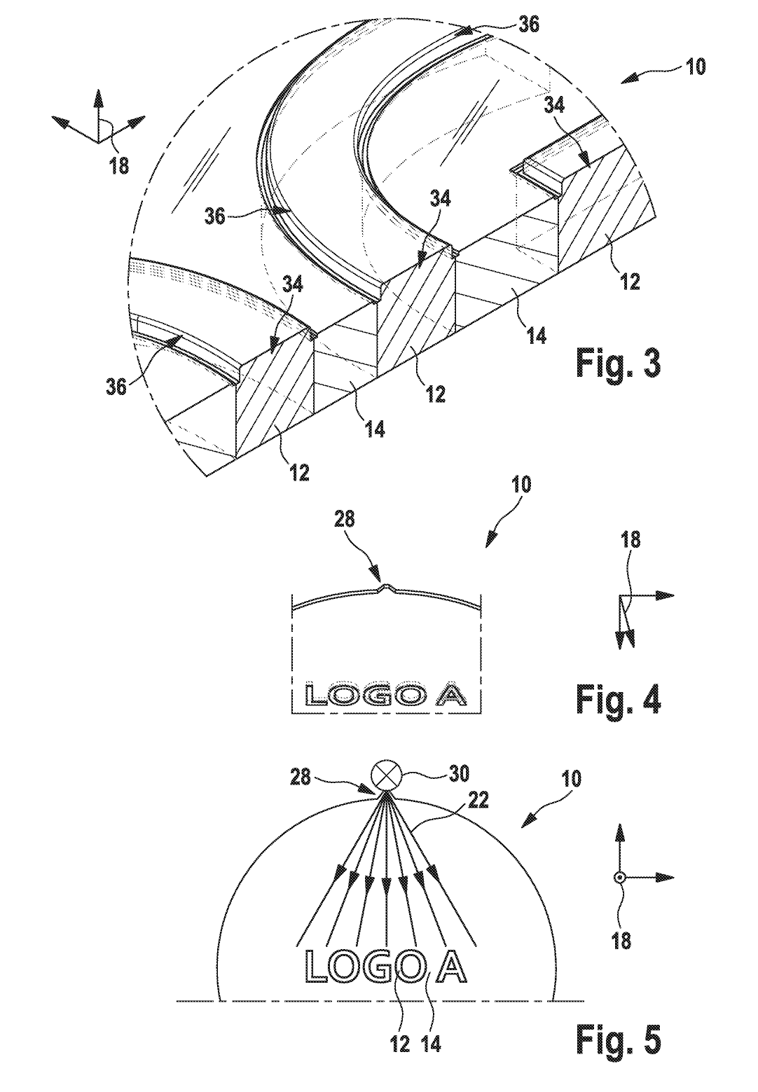

FIG. 3 shows a magnification from the view according to FIG. 2 along the cutting line 32, where it can be seen that the first material 12 protrudes in the direction of the normal vector 18 beyond the second material 14 with a projection or protrusion 34. The protrusion 34 comprises several rounded edges 36, only some of which are marked with reference numerals. It can also be seen that in this embodiment, the second material 14 is arranged only next to the first material 12 in relation to the normal vector 18. When looking at the transparent structure 10 along the normal vector 18, there is no second material 14 in front of or behind the first material 12.

Furthermore, it is shown that the transition from the first material 12 to the second material 14 takes place on the surface of the transparent structure 10 in the form of a trench whose surface is recessed relative to the normal vector 18 relative to the surface of the first material 12 and the surface of the second material 14. In this way, the separation between materials 12, 14 is particularly well perceptible and thus the shaping of materials 12, 14, especially the first material 12, is particularly well perceptible. This feature is independent of the protrusion 34 and the rounded edges 36.

FIG. 4 shows a perspective view from above onto the transparent structure 10 according to FIG. 1, where the shape of the coupling area 28 is clearly visible, which has the shape of a triangle with a flattened tip when viewed along the normal vector 18.

FIG. 5 shows a display device 38 with a transparent structure 10 and a light source 30, which is configured to couple light 22 at least approximately perpendicular to the normal vector 18 into the structure 10. It should be noted that light source 30 does not have to couple light 22 exclusively perpendicular to the normal vector 18 into the structure 10. However, it is considered advantageous if the design of light source 30 is configured to couple as much light as possible into structure 10 at least approximately perpendicular to normal vector 18.

In connection with FIG. 5 it should be noted that it is considered advantageous if the distribution of light 22 from light source 30 over the coupling region 28 covers all areas of the first material 12 directly.

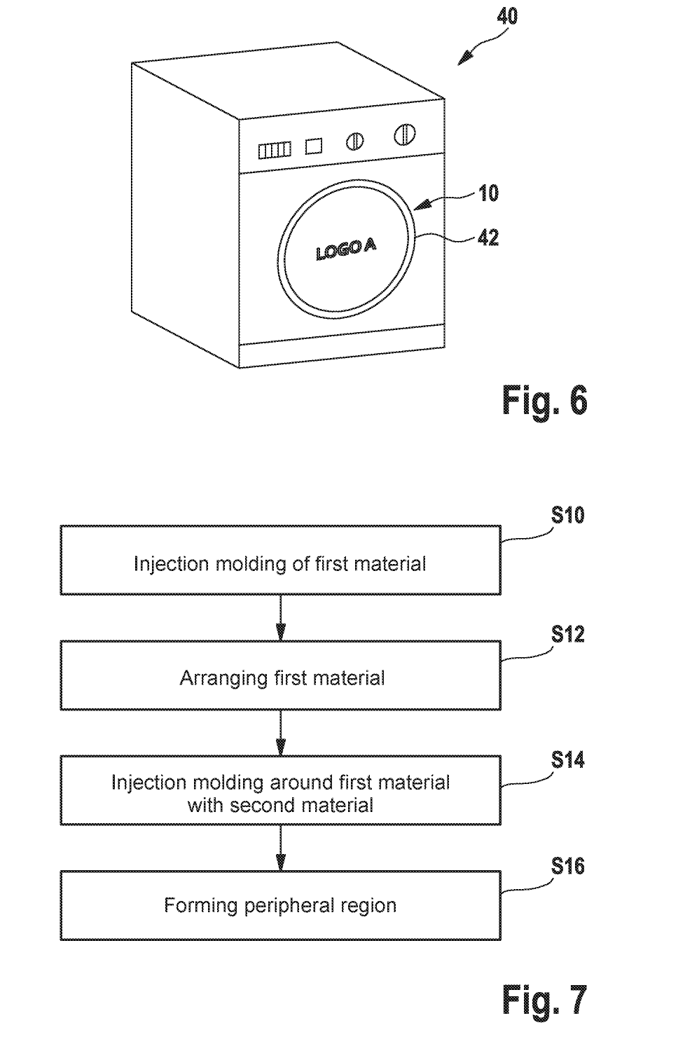

FIG. 6 shows a household appliance 40, here a washing machine, with a porthole 42, whereby the porthole 42 comprises the structure 10.

FIG. 7 shows a method 44 for producing a transparent structure 10. In a first step S10 at least one first element is produced by injection molding from a first material 12, which has a high first transparency with a scattering property. The scattering property is such that light 22, propagating perpendicular to the normal vector 18 of plane 16 of the structure 10, is deflected at least partially to the direction of the normal vector 18.

In a second step S12, the first element is arranged in the plane 16. Then, in step S14, second element of a second material 14 which has a high first transparency is injection molded around the at least one first element in order to obtain structure 10. In exemplary embodiments this is done via overmolding. The first and second materials 12, 14 are then arranged in the plane 16 and a view through the structure 10 in the direction of the normal vector 18 is given.

Finally, in step S16, a peripheral region 20 is formed, which is configured at least for the most part in such a reflective manner that light 22 propagating in the structure at least approximately perpendicular to the normal vector 18, is reflected back from peripheral region 20 into structure 10.

In the simplest case, the formation of the peripheral area 20 results from the step of overmolding S14, but additional steps can also be used, such as polishing, mirroring or coating, to form the peripheral area 20.

What is claimed is:

1. A transparent structure comprising a first material having a high first transparency with a scattering property and a second material having a high second transparency, wherein the first and second materials are arranged in a plane with a normal vector and a view through the structure is given in the direction of the normal vector, the structure having a peripheral region, which is configured at least for the most part such that light propagating in the structure at least approximately perpendicular to the normal vector is reflected from the peripheral region back into the structure, and wherein the scattering property is such that light propagating perpendicular to the normal vector within the structure is deflected at least partially to the direction of the normal vector.

2. The transparent structure of claim 1, wherein the plane is at least approximately parallel to a surface of the structure.

3. The transparent structure of claim 1, wherein at least one of the first transparency and the second transparency has an ASTM 1003 Haze value of less than 10%.

4. The transparent structure of claim 1, wherein at least one of the first transparency and the second transparency has an ASTM 1003 Haze value of less than 15%.

5. The transparent structure of claim 1, wherein an element reflecting light into the interior of the structure is arranged on the peripheral region.

6. The transparent structure of claim 1, wherein a reflecting layer reflecting light into the interior of the structure is arranged on the peripheral region.

7. The transparent structure of claim 1, the transmittance of the first material in the direction of the normal vector being 85%-96%.

8. The transparent structure of claim 1, the transmittance of the first material in the direction of the normal vector being 88%-93%.

9. The transparent structure of claim 1, the refractive index of the first material being 1.4 to 1.6.

10. The transparent structure of claim 1, the refractive index of the first material being 1.48 to 1.51.

11. The transparent structure of claim 1, wherein a coupling region is formed at the peripheral region such that light from a light source is substantially uniformly coupled into the structure, wherein the coupled light propagates at least approximately perpendicular to the normal vector.

12. The transparent structure of claim 1, the peripheral region having a substantially circular shape.

13. The transparent structure of claim 1, the first material protruding with a protrusion in the direction of the normal vector beyond the second material.

14. The transparent structure of claim 13, the protrusion having at least one of a rounded and a chamfered edge.

15. The transparent structure of claim 1, wherein the second material is arranged only sideways to the first material with respect to the normal vector.

16. A display device having a transparent structure according to claim 1 and a light source configured to couple light into the structure at least approximately perpendicular to the normal vector.

17. The display device of claim 16 further comprising a controller adapted to control the brightness of the light source based on information from a brightness sensor detecting an environmental brightness.

18. A washing machine, in particular washing machine/dryer, having a porthole and a transparent structure according to claim 1, the porthole comprising the structure.

19. A method for forming the transparent structure of claim 1, the method comprising the steps of:
injection molding of at least one first element from a first material having a high first transparency with a scattering property,
arranging the at least one first element in a plane with a normal vector,
injection molding of a second element from a second material having a high first transparency around the at least one first element to obtain the structure, the first and second materials being arranged in the plane and a view through the structure being given in the direction of the normal vector, and
forming of a peripheral region configured reflectively so that at least for the most part light propagating in the structure at least approximately perpendicular to the normal vector is reflected from the peripheral region back into the structure,
wherein the scattering property is such that light propagating perpendicular to the normal vector through the structure is at least partially deflected to the direction of the normal vector.
